(19) United States
(12) Patent Application Publication
(10) Pub. No.: US 2014/0332086 A1
(43) Pub. Date: Nov. 13, 2014

(54) Fluid Supplying System and Method for Supplying Fluid

(71) Applicant: SHENZHEN CHINA STAR OPTOELECRONICS TECHNOLOGY CO., LTD., Shenzhen, Guangdong (CN)

(72) Inventor: Ming Liu, Shenzhen City (CN)

(73) Assignee: Shenzhen China Star Optoelectronics Technology Co., Ltd., Shenzhen, Guangdong (CN)

(21) Appl. No.: 13/980,929

(22) PCT Filed: Jun. 27, 2013
(86) PCT No.: PCT/CN2013/078190

§ 371 Date: Jul. 22, 2013

(30) Foreign Application Priority Data
May 8, 2013 (CN) 201310167212.4

(51) Int. Cl. G02F 1/1333

(52) U.S. Cl. CPC G02F 1/1333
USPC 137/2; 137/391

(57) ABSTRACT

The present invention relates to a fluid supplying system which includes a supplying chamber including a supplying conduit, a first inlet and a first outlet, wherein the conduit has one end interconnected to the first outlet and the supplying chamber, and the other end interconnected to production equipment for supplying fluid from the supplying chamber to the production equipment. And a replenishing chamber includes a replenishing conduit, a second inlet and a second outlet, wherein the replenishing chamber is interconnected to the supplying chamber through the second inlet, and the other end is interconnected to a fluid container for replenishing fluid into the replenishing chamber, wherein the second outlet is interconnected to the first inlet for transferring the fluid from the replenishing chamber to the supplying chamber. By the combination of the supplying chamber and the replenishing chamber, the production equipment can be continuously replenished with fluid so as to avoid the shutdown of the operation resulted from replacing the fluid container.

### FIELD OF THE INVENTION

The present invention relates to a technical field of supplying or unloading mechanism, and more particularly, to a fluid supplying system for the liquid crystal display.

### DESCRIPTION OF PRIOR ART

In the technical field of liquid crystal display, there are a lot of liquid material to be used during the manufacturing processes, such as polyimide (PI) solution, liquid crystal (LC), sealant, and solvents, i.e. cleaning agent, N-Methyl Pyrrolidone (NMP), etc. Among them, the PI and LC are most expensive. As a result, the container for those material is comparatively smaller, ranging from 50˜500 ml. In the existing factory of mass production, changing of material will exhaust a great deal of time. In addition, there is always residue left in the container, and this deteriorates the waste.

In the production of the liquid crystal display, the quantity left in the container has to monitor minute by minute so as to replenish or replace it in time. Each time, the change or replacement of the fluid will halt the production line about 25 minutes. If the halting time for the production line becomes longer, then a certain waste of the production equipment will be encountered. In order to ensure the production equipment operates normally, then the fluid containers have to be replaced more frequently, and each time, about 10% of the material will be wasted.

### SUMMARY OF THE INVENTION

In order to improve the issue of material waste and delay of production resulted from frequently replacing the fluid container. The present invention also provides a fluid supplying device and a method for supplying the fluid.

The fluid supplying system, including:

a supplying chamber including a supplying conduit, a first inlet and a first outlet, wherein the conduit has one end interconnected to the first outlet and the supplying chamber, and the other end interconnected to production equipment for supplying fluid from the supplying chamber to the production equipment; and

a replenishing chamber including a replenishing conducit, a second inlet and a second outlet, wherein the replenishing chamber is interconnected to the supplying chamber through the second inlet, and the other end is interconnected to a fluid container for replenishing fluid into the replenishing chamber, wherein the second outlet is interconnected to the first inlet for transferring the fluid from the replenishing chamber to the supplying chamber.

Preferably, wherein a valve is arranged between the first inlet and the second outlet so as to control the communication between the supplying chamber and the replenishing chamber.

Preferably, wherein the supplying chamber further includes an inner duct interconnected to the first inlet and mounted onto an inner wall of the supplying chamber so as to introduce the fluid from the replenishing chamber into the supplying chamber.

Preferably, wherein the replenishing conduit is mounted on an inner wall of the replenishing chamber so as to introduce fluid from the fluid container into the replenishing chamber.

Preferably, further includes a vacuum device interconnected to the replenishing chamber with a hose so as to defoam the bubbles within the fluid replenished into the replenishing chamber.

Preferably, wherein the second inlet, the second outlet are disposed diagonally on the upper and lower corners of the replenishing chamber.

Preferably, wherein the supplying chamber is defined with ventilation orifices in communication with the ambient environment.

Preferably, wherein the supplying and replenish chambers are each provided with a detecting device so as to check the fluid level within the supplying chamber and the replenishing chamber.

Preferably, wherein the supplying system further includes an on-line monitoring system so as to control one of or more than one of the operation of the vacuum device, detecting devices, fluid container, production equipment or valve.

The present invention further provides a method for supplying fluid, and includes the following steps.

S1: a command from on-line monitoring system to facilitate pouring of fluid from fluid container into the replenishing chamber, turning on the vacuum device so as to defoam the fluid poured in;

wherein when the detecting device of the replenishing chamber detects the fluid level is lower than the minimum level of the fluid, the on-line monitoring system will keep on pouring the fluid from the fluid container into thee replenishing chamber;

wherein when the detecting device of the replenishing chamber detects the fluid level is higher than the minimum level of the fluid, but lower then the maximum level, then the on-line monitoring system will turn on the valve, while keeping on pouring the fluid from the fluid container into thee replenishing chamber;

wherein when the detecting device of the replenishing chamber detects the fluid level is higher than the maximum level of the fluid, the on-line monitoring system will stop pouring the fluid from the fluid container into thee replenishing chamber;

S2: transferring fluid from the replenishing chamber into the supplying chamber;

wherein when the detecting device of the supplying chamber detects the fluid level is lower then the minimum level, the on-line monitoring system will keep the valve opened so as to continue transfer of fluid into the supplying chamber;

wherein when the detecting device of the supplying chamber detects the fluid level is higher than the minimum level of the fluid, but lower then the maximum level, then the on-line monitoring system will turn on the manufacturing equipment and receive fluid from thee supplying chamber to start production;

wherein when the detecting device of the supplying chamber detects the fluid level is higher than the maximum level of the fluid, the on-line monitoring system will stop pouring the fluid from the replenishing chamber into the supplying chamber; and

repeating steps S1 and S2.

The present invention can be concluded with the following advantages. By the combination of the supplying chamber and the replenishing chamber, the production equipment can be continuously replenished with fluid so as to avoid the shutdown of the operation resulted from replacing the fluid container. In addition, the vacuum device is preferred provided to defoam so as to remove any bubbles contained within the fluid during the replenishment. Since the fluid is continuously supplied, and no waste of the fluid is experienced resulted from the fluid container is inadversely replaced in order to keep the production equipment running. The present invention can effectively reduce the exhaust of the fluid. Cost is reduced, and the utilization aspect for future is excellent.

### BRIEF DESCRIPTION OF DRAWINGS

FIG. 1 is an illustrational view of a fluid supplying system made in accordance with a first embodiment of the present invention; and

FIG. 2 is an illustrational view of a fluid supplying system made in accordance with a second embodiment of the present invention.

### DETAILED DESCRIPTION OF PREFERRED EMBODIMENT

Detailed description of preferred embodiments will be given herebelow along with accompanied drawings.

### Embodiment I

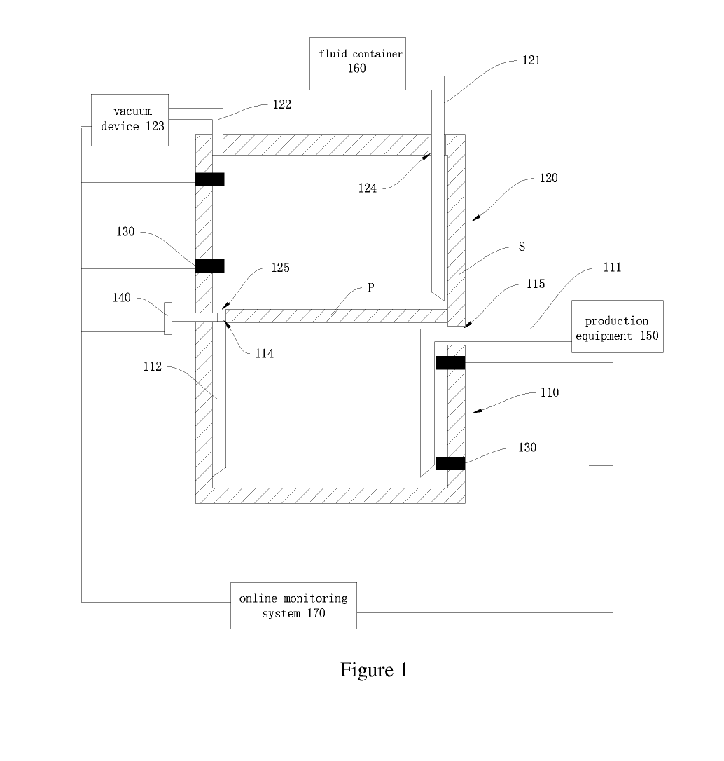

As shown in FIG. 1, the fluid supplying system includes at least a supplying chamber 110 and a replenishing chamber 120.

Firstly, the supplying chamber 110 includes a supplying conduit 111, a first inlet 114, and a first outlet 115. The first inlet 114 is arranged on one side of the top of the supplying chamber 110, and the first outlet 115 is arranged on the sidewall S of the supplying chamber 110 in the position adjacent to the top. Of course, in other preferred embodiment, the first outlet 115 can also be arranged on bottom of the supplying chamber 110 for directing output the fluid so as to maximize the output of the fluid contained within the supplying chamber 110. The other end of the supplying conduit 111 is interconnected to the production equipment 150 so as to deliver the fluid within the supplying chamber 110 to the production equipment 150.

Wherein, in order to have the fluid contained in the supplying chamber 110 be quickly delivered to the production equipment 150, the supplying chamber 110 has to be kept with a certain air pressure, and this can be readily facilitated by providing a ventilation hole on the sidewall of the supplying chamber 110. In the current embodiment, a slit is defined between the supplying conduit 111 and the first outlet 115 such that the supplying chamber 110 is in communication with the ambient environment. By the provision of the slit serving as a ventilation hole, the ambient air can readily enter the supplying chamber 110 so as to keep the supplying chamber 110 under certain atmosphere pressure.

Wherein the supplying chamber 110 further includes a supplying conduit 112 interconnected to the first inlet 114, and extends along the side wall S of the supplying chamber 110 to a height about one fifth of the overall length of the sidewall S. The provision of the supplying conduit 112 is to direct the fluid from the first inlet 114 to flow down along the sidewall so as to prevent foaming of the fluid.

As shown in FIG. 1, the replenish chamber 120 is disposed above the supplying chamber 110. Substantially, in the current embodiment, the sidewall S of the supplying chamber 110 extends upward so as to become a common sidewall of both the replenishing chamber 120 and the supplying chamber 110. A partition P is used to separate the replenishing chamber 120 and the supplying chamber 110, i.e. the partition P is the ceiling of the supplying chamber 110, and the bottom of the replenishing chamber 120.

The replenishing chamber 120 includes a replenishing conduit 121, a second inlet 124 and a second outlet 125. The second inlet 124 is arranged on a side of the top of the replenish chamber 120, and the second outlet 125 is disposed on a side of the bottom of the replenishing chamber 120. The first inlet 114 is align with the second outlet 125 such that the fluid from the replenishing chamber 120 can flow to the supplying chamber 110 through the second outlet 125 and the first inlet 114. In the current embodiment, the first inlet 114 or the second outlet 124 are both disposed on a notch defined between the partition P and the sidewall S. In the position of the notch between the partition P and the sidewall S, a valve 140 is installed, and which is used to control the open or close of the passage between the supplying chamber 110 and the replenishing chamber 120. Accordingly, the fluid can be controlled to flow into the supplying chamber 110 at the proper timing.

One end of the replenishing conduit 121 is interconnected to the replenishing chamber 120 through the second inlet 124 and extends further down along the sidewall S of the replenishing chamber 120 to a position about one fifth of the length of the sidewall S. This is to ensure that the fluid can flow into the replenishing chamber 120 along sidewall S when it is delivered from the fluid container 160 through the second inlet 124 so as to reduce the bubbling. The replenishing conduit 121 is interconnected to the fluid container 160 with another end so as to replenish the replenishing chamber 120.

Furthermore, the bubbles within the fluid will bring a negative influence to the production equipment 150 once it enters into the system. Accordingly, the supplying system has to defoam the bubbles within the fluid. As a result, a vacuum device 123 is provided so as to defoam the bubbles within the fluid. The vacuum device 123 is interconnected to the replenishing chamber 120 with a hose 122 so as to conduct a defoaming process when the fluid flows into the replenishing chamber 120. In order to ensure enough defoaming time when the fluid flows from the replenishing chamber 120 to the supplying chamber 110, the second inlet 124 and the second outlet 125 are arranged diagonally on the upper and lower corners of the replenishing chamber 120 so as to get a maximum distance between the second inlet 124 and the second outlet 125. Meanwhile, since the replenishing chamber 120 has to be kept under vacuum condition, there is a sealant sealed on the joints located between the second inlet 124 and the replenishing conduit 121, and the hose 122 and the replenishing chamber 120.

In both the replenishing chamber 120 and the supplying chamber 110, a plurality of detecting devices 130 are installed. For example, the detecting devices 130 are installed on the minimum level and maximum level of the replenishing chamber 120 so as to check the lowest level and highest level of the fluid. In general, the highest level is set on about four fifth of the height of the replenishing chamber 120, and the lowest level is set to one fifth of the overall height of the replenishing chamber 120. Accordingly, once the fluid level exceeds or lowers such levels, a warning signal will be given so as to keep a normal operation of the system. Similarly, the supplying system 110 is also provided with the detecting devices 130 located on one fifth of the height of the supplying chamber 110 and also the position located below the first outlet 115. The function of the detecting device 130 are same as above. According to the present invention, the first outlet 115 is defined on the sidewall S of the supplying chamber 110, accordingly, the highest level of the fluid is set to a position four fifth of a distance from the first outlet 115 to the bottom.

In order to accurately control the operation of the all devices, the vacuum device 123, the fluid container 130, the production equipment 150, the valve 140, and the detecting device 130 are all electrically connected to an on-line monitoring system 170. Through the online monitoring system 170, the supplying of the fluid to the production equipment 150 can be readily controlled.

The method for supplying the fluid will be elaborated below.

S1: installing all device and equipment according to FIG. 1, and have the valve 140 closed such that the replenishing chamber 120 and the supplying chamber 110 are separated from each other. A command from the on-line monitoring system will have the fluid container 160 start to pour fluid into the replenish chamber 120 through the replenishing conduit 121. Meanwhile, the vacuum device 123 will start to opiate according to the command from the online monitoring system 170 so as to start the defoaming process toward the fluid within the replenishing chamber 120. The vacuum is kept under 0.1 atm. Under such vacuum environment, the bubbles will burst out because of expansion and thereby eliminating all bubbles trapped within the fluid.

With the fluid keeps flowing into the replenish chamber 120 till it reaches to the minimum level, i.e. one fifth of the height of the replenish chamber 120, the online monitoring system 170 will keep the fluid container 160 opened to keep pouring fluid into the replenishing chamber 120.

When the fluid level of the replenishing chamber 120 detected by the detecting device 130 reaches to a level lower than the maximum level (for example, four fifth of the height of the replenishing chamber 120) but higher than the minimum level, the online monitoring system 170 will open the valve 140 and start to deliver the fluid from the replenishing chamber 120 into the supplying chamber 110, while the fluid container 160 is kept opened.

When the detecting device 130 of the replenishing chamber 120 senses that the fluid level has reached to the maximum level, the online monitoring system 170 will shutdown the fluid container 160, and the fluid stops entering the replenish chamber 120.

S2: With the fluid constantly flows into the supplying chamber 110 from the replenishing chamber 120, the fluid flows slowly along the supplying conduit 112 into the supplying chamber 110. With the guidance of the supplying conduit 112, the fluid enters into the supplying chamber 110 along its sidewall or inner wall of the supplying conduit 112. Accordingly, no bubbles are created.

When the detecting device 130 of the supplying chamber 110 senses that the fluid level is lower then the minimum level, i.e. one fifth of the height of the supplying chamber 110, then an alarm will be triggered by the detecting device 130 and the online monitoring system 170 will keep the valve 140 opened to supply the fluid continuously.

When the detecting device 130 of the supplying chamber 110 senses that the fluid level is higher than the minimum level, but lower than the maximum level, i.e. four fifth of the height of the supplying chamber 110, then the detecting device 130 will trigger an alarm, and the online monitoring system 170 will command the production equipment 150 to operate, drawing fluid from the supplying chamber 110 to start production. Meanwhile, a sampling device (not shown in Figure) of the production equipment 150 will supply the fluid to the production equipment 150 through the supplying conduit 111. The ventilation hole of the supplying chamber 110 will be kept open so as the have the supplying chamber 110 contains with sufficient atmosphere pressure so as to push the fluid into the production equipment 150 to manufacture product.

When the detecting device 130 of the supplying chamber 110 senses the fluid has reached to the maximum level, the detecting device 130 will trigger an alarm, and the online monitoring system 170 will keep the production equipment running, but turning off the valve 140 to stop delivering fluid into the supplying chamber 110.

After a period of time, with the exhaustion of the fluid contained within the supplying chamber 110, and when the fluid level reaches to the minimum level, the detecting device 130 will trigger again the alarm, and the online monitoring system 170 will turn on the valve 140, and the fluid contained within the replenishing chamber 120 will flow into the supplying chamber 110 in time.

Repeating steps S1 and S2.

### Embodiment II

As compared to Embodiment I, the current embodiment has the following improvement.

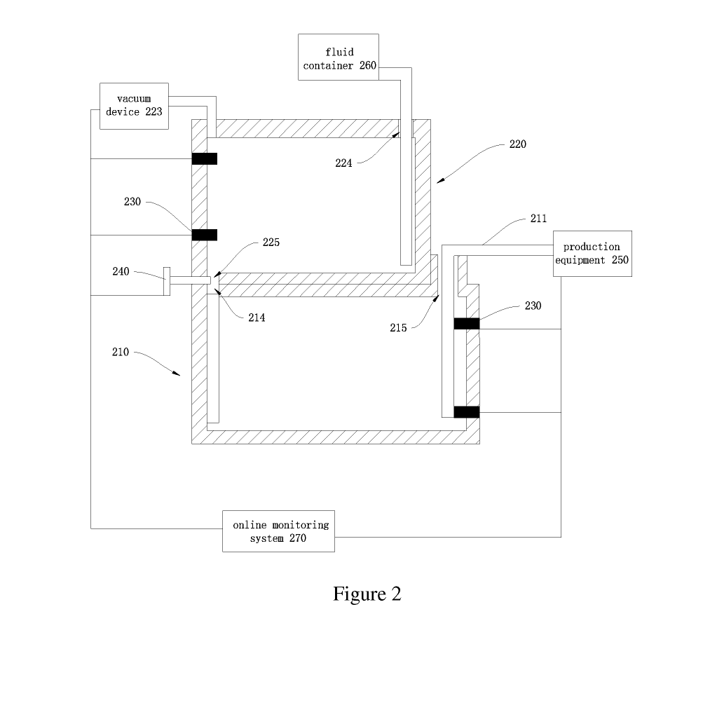

As shown in FIG. 2, the replenishing chamber 220 and the supplying chamber 210 are formed individually such that both can be conveniently dismounted and replaced. Similarly, a second outlet 225 located on a side of the bottom of the replenishing chamber 220 is arranged connected to a first inlet 214 located on top of the supplying chamber 210.

In addition, the supplying chamber 210 disposed under the replenishing chamber 220 has a dimension larger then the replenishing chamber 220. A first inlet 215 is defined on the top of the supplying chamber 210 which extends over the replenishing chamber 220. The supplying conduit 211 is disposed within a first outlet 215, and a gap is kept before the outlet 215 so as to serve ventilation with the ambient environment. Of course, a siphon (not shown in Figure) can be disposed onto the location of the first outlet 215 of the supplying chamber 310 to serve as a ventilation hole to the ambient environment. The advantages of this design is that the first outlet 215 is arranged on top of the supplying chamber 210 such that the maximum level of the fluid of the supplying chamber 210 is also lifted, and will not be limited to the location of the first outlet 215. Accordingly, the volume of the supplying chamber 210 can be enlarged. Corresponding, the detecting device 230 within the supplying chamber 210 can also be lifted up to four fifth of the height of the supplying chamber.

Configurations of other devices as well as the working procedures of the fluid supplying system can be referred to Embodiment I.

1. A fluid supplying system, including:
a supplying chamber including a supplying conduit, a first inlet and a first outlet, wherein the conduit has one end interconnected to the first outlet and the supplying chamber, and the other end interconnected to production equipment for supplying fluid from the supplying chamber to the production equipment;
a replenishing chamber including a replenishing conduit, a second inlet and a second outlet, wherein the replenishing chamber is interconnected to the supplying chamber through the second inlet, and the other end is interconnected to a fluid container for replenishing fluid into the replenishing chamber, wherein the second outlet is interconnected to the first inlet for transferring the fluid from the replenishing chamber to the supplying chamber; and
a vacuum device interconnected to the replenishing chamber through a hose so as to defoam the bubbles within the fluid replenished into the replenishing chamber, wherein the second inlet, the second outlet are disposed diagonally on the upper and lower corners of the replenishing chamber.

2. A fluid supplying system, including:
a supplying chamber including a supplying conduit, a first inlet and a first outlet, wherein the conduit has one end interconnected to the first outlet and the supplying chamber, and the other end interconnected to production equipment for supplying fluid from the supplying chamber to the production equipment; and
a replenishing chamber including a replenishing conduit, a second inlet and a second outlet, wherein the replenishing chamber is interconnected to the supplying chamber through the second inlet, and the other end is interconnected to a fluid container for replenishing fluid into the replenishing chamber, wherein the second outlet is interconnected to the first inlet for transferring the fluid from the replenishing chamber to the supplying chamber.

3. The fluid supplying system as recited in claim 2, wherein a valve is arranged between the first inlet and the second outlet so as to control the communication between the supplying chamber and the replenishing chamber.

4. The supplying system as recited in claim 2, wherein the supplying chamber further includes an inner duct interconnected to the first inlet and mounted onto an inner wall of the supplying chamber so as to introduce the fluid from the replenishing chamber into the supplying chamber.

5. The fluid supplying system as recited in claim 2, wherein the replenishing conduit is mounted on an inner wall of the replenishing chamber so as to introduce fluid from the fluid container into the replenishing chamber.

6. The fluid supplying system as recited in claim 2, further including a vacuum device interconnected to the replenishing chamber with a hose so as to defoam the bubbles within the fluid replenished into the replenishing chamber.

7. The fluid supplying system as recited in claim 6, wherein the second inlet, the second outlet are disposed diagonally on the upper and lower corners of the replenishing chamber.

8. The fluid supplying system as recited in claim 2, wherein the supplying chamber is defined with ventilation orifices in communication with the ambient environment.

9. The fluid supplying system as recited in claim 2, wherein the supplying chamber is provided with a detecting device so as to check the fluid level within the supplying chamber.

10. The fluid supplying system as recited in claim 2, wherein the replenishing chamber is provided with a detecting device so as to check the fluid level within the replenishing chamber.

11. The fluid supplying system as recited in claim 2, wherein the supplying system further includes an on-line monitoring system so as to control the operation of the supplying system.

12. A method for supplying fluid by using a fluid supplying system including:
a supplying chamber including a supplying conduit, a first inlet and a first outlet, wherein the conduit has one end interconnected to the first outlet and the supplying chamber, and the other end interconnected to production equipment for supplying fluid from the supplying chamber to the production equipment; and
a replenishing chamber including a replenishing conduit, a second inlet and a second outlet, wherein the replenishing chamber is interconnected to the supplying chamber through the second inlet, and the other end is interconnected to a fluid container for replenishing fluid into the replenishing chamber, wherein the second outlet is interconnected to the first inlet for transferring the fluid from the replenishing chamber to the supplying chamber;
an on-line monitoring system so as to control the operation of the supplying system;
wherein the supplying system further comprising:
a valve arranged between the first inlet and the second outlet;
a vacuum device interconnected to the replenishing chamber through a hose so as to defoam the bubbles within the fluid replenished into the replenishing chamber;
wherein the supplying chamber is provided with a detecting device so as to check the fluid level within the supplying chamber;
wherein the replenishing chamber is provided with a detecting device so as to check the fluid level within the replenishing chamber;
wherein the method includes the following steps:
S1: a command from on-line monitoring system to facilitate pouring of fluid from fluid container into the replenishing chamber, turning on the vacuum device so as to defoam the fluid poured in;
wherein when the detecting device of the replenishing chamber detects the fluid level is lower than the minimum level of the fluid, the on-line monitoring system will keep on pouring the fluid from the fluid container into thee replenishing chamber;
wherein when the detecting device of the replenishing chamber detects the fluid level is higher than the minimum level of the fluid, but lower then the maximum level, then the on-line monitoring system will turn on the valve, while keeping on pouring the fluid from the fluid container into thee replenishing chamber;
wherein when the detecting device of the replenishing chamber detects the fluid level is higher than the maximum level of the fluid, the on-line monitoring system will to stop pouring the fluid from the fluid container into thee replenishing chamber;
S2: transferring fluid from the replenishing chamber into the supplying chamber;
wherein when the detecting device of the supplying chamber detects the fluid level is lower then the minimum level, the on-line monitoring system will keep the valve opened so as to continue transfer of fluid into the supplying chamber;
wherein when the detecting device of the supplying chamber detects the fluid level is higher than the minimum level of the fluid, but lower then the maximum level, then the on-line monitoring system will turn on the manufacturing equipment and receive fluid from thee supplying chamber to start production;
wherein when the detecting device of the supplying chamber detects the fluid level is higher than the maximum level of the fluid, the on-line monitoring system will stop pouring the fluid from the replenishing chamber into the supplying chamber; and
repeating steps S1 and S2.

13. The method as recited in claim 12, wherein the supplying chamber further includes an inner duct interconnected to the first inlet and mounted onto an inner wall of the supplying chamber so as to introduce the fluid from the replenishing chamber into the supplying chamber.

14. The method as recited in claim 12, wherein the replenishing conduit is mounted on an inner wall of the replenishing chamber so as to introduce fluid from the fluid container into the replenishing chamber.

15. The method as recited in claim 12, wherein the second inlet, the second outlet are disposed diagonally on the upper and lower corners of the replenishing chamber.

16. The method as recited in claim 12, wherein the supplying chamber is defined with ventilation orifices in communication with the ambient environment.
